(19) United States
(12) Patent Application Publication
(10) Pub. No.: US 2026/0127882 A1
(43) Pub. Date: May 7, 2026

(54) METHOD AND SYSTEM FOR IDENTIFYING A VEHICLE VIA A SYSTEM

(71) Applicant: Ford Global Technologies, LLC, Dearborn, MI (US)

(72) Inventors: Joseph Andreas Urhahne, Pulheim/NRW (DE); Frederic Christen, Hergenrath/Liege (BE); Eduardo Perez Guzman, Aachen/NRW (DE); Syed Amaar Ahmad, Canton, MI (US); Erik Wickop, Hamburg (DE)

(73) Assignee: Ford Global Technologies, LLC, Dearborn, MI (US)

(21) Appl. No.: 19/241,945

(22) Filed: Jun. 18, 2025

(30) Foreign Application Priority Data
Jun. 28, 2024 (DE) 102024118464.7

(51) Int. Cl. G06V 20/50; B60S 1/06; E05F 15/70; G06T 7/246

(52) U.S. Cl. CPC G06V 20/50; B60S 1/06; E05F 15/70; G06T 7/246; E05Y 2900/55; G06T 2207/30248; G06V 2201/08

(57) ABSTRACT

The disclosure relates in general to a method and a system for identifying a vehicle via a system. The system comprises at least one sensor, a system control device coupled to the sensor and the vehicle having a vehicle control device. A vehicle having at least one component is detected. The component is movable, can be detected by the sensor and is coupled to the vehicle control device. The system control device is coupled to the vehicle control device. An identifier is forwarded by the system control device to the vehicle control device. A movement pattern is executed by the at least one component of the vehicle based on the identifier. A movement pattern executed by the component of the vehicle is detected by the sensor. The vehicle is identified by the system control device (16) based on the detected movement pattern.

### CROSS-REFERENCE TO RELATED APPLICATION

This patent application claims priority to German Application No. DE 102024118464.7 filed on Jun. 28, 2024, which is hereby incorporated by reference in its entirety.

### BACKGROUND

WO 2020/229015 A1 discloses a system in which a vehicle has a visible movable component and vehicle-surroundings sensor technology. The system also comprises an access authorization system. An evaluation unit evaluates information from the vehicle-surroundings sensor technology and/or the access authorization system and controls the at least one movable component depending on the evaluation for interaction with other traffic participants in the vehicle surroundings.

U.S. Pat. No. 9,855,890 B2 discloses a system in which, in contrast to WO 2020/229015 A1, an autonomous vehicle interacts with the surrounding environment. After detecting an object in the surrounding environment, for example a person, the vehicle may issue an alert to the object, for example an audible alert or the opening of a window.

However, with these approaches, the movement of the component is based only on data from the surroundings sensor technology of the vehicle. Vehicle identification is therefore not enabled.

U.S. Pat. Nos. 9,666,075 B2 and 11,227,496 B1 disclose systems for controlling vehicles in autonomous control areas. The systems comprise identification detectors, which are designed to detect license plate numbers of the vehicles. Cameras may be used for this purpose.

DE 10 2016 200 794 A1, DE 10 2022 209 336 A1, DE 10 2012 021 403 A1, and DE 10 2017 011 762 A1 disclose vehicle identification procedures.

However, this means that only camera-based systems may be used for the actual identification. Moreover, the identification is only possible in respect of specific components, for example license plate numbers. The application scenarios are consequently very limited. For example, parameters of the vehicles which are associated with the particular license numbers must be previously known so that the system may ascertain the particular vehicle type. Moreover, the detection is dependent on the optical conditions.

### SUMMARY

The disclosure relates in general to a method and a system for identifying a vehicle via a system.

In certain application scenarios, vehicles are to be moved autonomously by superordinate control devices. For example, dedicated parking areas may be provided, in which vehicles are moved to designated parking spaces, and, depending on requirements, retrieved from these designated parking spaces, for example, in an autonomous and automated manner. To this end, a robust and reliable identification mechanism for the individual vehicles is needed so that unwanted movement of an unintended vehicle does not take place.

It would be useful to overcome, or at least reduce, the disadvantages of known methods for the identification of vehicles. In particular, it would be useful to provide a method and a system for identifying vehicles, which, on the one hand, are more robust than the known approaches, which are not dependent on previously known additional vehicle-based information and which may be used for more application scenarios, for example regardless of the optical conditions.

Advantageous configurations are indicated in the dependent claims and in the description below, each of which may represent aspects of the disclosure independently or in (sub)combinations. Some features are explained with respect to methods, others with respect to devices. However, corresponding aspects are mutually transferable in a corresponding manner.

According to one aspect, some embodiments of the disclosure relate to a method for identifying a vehicle via a system. The system comprises at least one sensor, a system control device coupled to the sensor and the vehicle having a vehicle control device. The method comprises at least the following steps:
a vehicle having at least one component is detected. The component is movable, can be detected by the sensor and is coupled to the vehicle control device;
the system control device is coupled to the vehicle control device;
an identifier is forwarded by the system control device to the vehicle control device;
a movement pattern of the at least one component of the vehicle is executed based on the identifier;
a movement pattern executed by the component of the vehicle is detected by the sensor;
the vehicle is identified by the system control device based on the detected movement pattern.

As a result, a method is provided via which a vehicle may be identified in a precise and variable manner. This is achieved in that the method is not limited to identifying vehicles purely on the basis of the license plates. In contrast to previous approaches, the identification is based on recognizing vehicles from a movement pattern of a movable vehicle component. Consequently, the identification is essentially not dependent on the license plate (number) and is also not dependent on vehicle-surroundings sensor technology that may not even be present. In addition, the integrity of the identification method may be ensured with the aid of a forwarded identifier, since an expected movement pattern may be associated with the particular identifier. In this regard, it is not necessary to firstly generate a database of vehicle license plate numbers with which particular vehicle types are associated. Instead, a database which comprises the particular identifiers and vehicle types is generated irrespective of the information relating to a specific, individual vehicle (and its license plate number). The variability of the vehicle identification is therefore increased over that of previous approaches with the aid of the method illustrated here. In many applications, there is, in any case, no need to be able to determine the specific vehicle in question. Instead, in the majority of application cases, it is sufficient if the identification of the vehicle enables the ascertainment of the vehicle type since, for example, the particular vehicle dimensions are determined by the vehicle type. This is precisely what the method outlined here accomplishes.

In the application case of an autonomous or at least partly autonomous parking area, there is, for example, no need to ascertain whether a vehicle belongs to person A or person B on the basis of license plate detection. For autonomous parking procedures, however, it is helpful to know the vehicle type of a specific vehicle since, for example, the external dimensions of the vehicle are determined by the vehicle type. This opens up the possibility of being able to select a suitable parking space to which the particular vehicle shall be moved since the parking space has dimensions which are sufficient for the particular vehicle type. The system enables this information to be determined in that vehicles may be identified on the basis of the movement pattern at least of a movable vehicle component. The specific vehicle in question, i.e. to whom the vehicle belongs, is of no interest for the application cases outlined here and is not necessarily ascertained in the present case. Consequently, the database forming the basis for the identification may also contain less information than was previously the case, for example, and may therefore require less storage space.

In addition, the method is not limited to the effect that camera-based sensors must be used to detect the movement pattern. Instead, in contrast to previous approaches, sensors and other detection technologies may be used to detect the particular movement patterns. As a result, the variability of the method is also increased over that of previous approaches since the detection no longer depends (exclusively) on optical visibility conditions.

According to a further aspect, some embodiments of the disclosure relate to a system for identifying a vehicle. The system comprises at least one sensor, a system control device coupled to the sensor and the vehicle having a vehicle control device. The sensor is at least designed:
to detect a vehicle having at least one movable component which can be detected by the sensor and is coupled to the vehicle control device, and
to detect a movement pattern executed by the component of the vehicle.

The system control device and the vehicle control device can be coupled to one another.

The vehicle control device is designed to control the at least one component of the vehicle in such a way that it executes a movement pattern based on the identifier.

The system control device is at least designed:
to forward an identifier to the vehicle control device, and
to identify the vehicle based on the detected movement pattern.

The advantages achieved by the method described herein are also achieved in a corresponding manner by the presented system.

The system may be designed, in particular, as part of autonomous or partly autonomous vehicle management devices, for example parking areas, parking space areas or infrastructures in which vehicles are to be detected in an automated manner, for example in order to subsequently enable automated movement of a vehicle.

The identifier is such that it may be interpreted by the vehicle control device, which may derive from this a movement pattern to be (apparently) executed by the component. In this regard, the identifier comprises information which specifies a movement pattern to be executed by the at least one component.

A distinct movement pattern to be executed by the component may be stored in the identifier. The vehicle control device then ascertains the distinct movement pattern based on the received identifier and controls the component so that it executes the distinct movement pattern. In other words, a distinct movement pattern to be executed by the particular detected vehicle component may be encoded in the respective identifier. The vehicle control device may then be designed to decode the particular distinct movement pattern to be executed from the received identifier and to control the movable vehicle component so that it executes a movement pattern.

Generally speaking, as a result of the control with the aid of the vehicle control device, the subsequently executed movement pattern of the movable vehicle component will correspond to the movement pattern which is stored in the identifier. This may be detected with the aid of at least one sensor.

In the event of (generally) possible unwanted interference in the system, for example to obtain access to automated vehicle management systems, the movable vehicle component might also execute a movement pattern that does not correspond to the movement pattern which is stored in the identifier. Consequently, the detection of the executed movement pattern enables the integrity of the present identification method to be checked so that faulty vehicle identification does not occur. In other words, storing a specific movement pattern to be executed by the particular vehicle component in the identifier enables an additional protection barrier (protection level) via which the integrity of the present method is increased.

In some embodiments, the identifier may be stored in a database which is coupled to the system control device.

Alternatively or cumulatively, after the identifier has been forwarded by the system control device to the vehicle control device, the identifier may be stored within the vehicle, for example in a further database. The system control device and/or the vehicle control device may then be designed to interpret the identifier and therefore to ascertain or verify the movement pattern to be executed.

In one alternative, the system control device and/or the vehicle control device may be designed to ascertain or to verify the movement pattern to be executed on the basis of the transmission of the identifier itself. For example, the transmission of the identifier may be based on the, optionally encrypted, exchange of a code, for example a binary code, which may be interpreted in each case by an algorithm (as part of the system control device and/or the vehicle control device) in order to ascertain or to verify the movement pattern to be executed on both sides of the transmission. For example, the algorithm may be designed to ascertain a check sum via which the movement pattern to be executed is determined.

The identification of the vehicle may depend on the movement pattern detected by the sensor being compared with the distinct movement pattern which is stored in the identifier. As a result of this comparison, it may be decided whether the detected movement pattern corresponds to the distinct movement pattern which is stored in the identifier. If this is the case, it may be assumed that the integrity of the identification method in respect of the detection of the movement pattern executed by the movable vehicle component is ensured.

A particular vehicle type may be associated with a distinct movement pattern, which is stored in an identifier. The association between the distinct movement pattern, the identifier and the particular vehicle type may be ensured with the aid of a database, for example, to which at least the system control device is coupled. For example, the database may be stored in a memory, to which the system control device is coupled.

If the movement pattern of the movable vehicle component that is detected by the sensor corresponds to the distinct movement pattern which is stored in the identifier, the particular vehicle type with which the distinct movement pattern is associated may be read out from the database. The identification of the vehicle type of the particular vehicle is consequently ensured.

Alternatively, if the movement pattern of the movable vehicle component that is detected by the sensor does not correspond to the distinct movement pattern which is stored in the identifier, a fault may be present. An error message may be output as a result of the fault. In this case, the method may be repeated, for example. In addition, an alert which indicates the fault may be issued via a user interface. This may involve a request for a user input, which may specify how to deal with the fault.

In some embodiments, the movement pattern comprises at least one frequency-dependent or amplitude-dependent variation of a movement of the component of the vehicle. As a result, the variability of the movements which can be executed by the particular vehicle component is increased This enables various vehicle types to be identified based on different frequency-dependent or amplitude-dependent variations of a movement of an essentially similar component of the vehicle, for example a side window or an exterior mirror. In a simple example, a vehicle of a first vehicle type may be recognizable on the basis of a movement pattern in which the exterior mirror is folded and unfolded three times. However, a vehicle of another vehicle type may be recognizable in that the exterior mirror is folded and unfolded only twice. In addition, pause intervals between the various folding procedures may be varied. Or single or multiple folding procedures may be only partially executed (i.e. up to a half folded or unfolded position). Therefore, despite the use of similar vehicle components, vehicles of different vehicle types may be reliably differentiated from one another.

It goes without saying that, during the detection of the movement pattern, partial dimensions of the vehicle, for example dimensions of the particular movable vehicle component, may be detected, which are used to execute the particular movement pattern. Based on the respectively detected dimensions, additional information may be provided, which may likewise be used for vehicle identification.

The vehicle may have multiple components that are used to execute the movement pattern and are detected by the at least one sensor. As a result, the variability of the method is further increased since more complex movement patterns are enabled, for example with the aid of multiple, at least partially moved components. As a result, the parameter space is ultimately increased in order to define particular distinct movement patterns in order to be able to differentiate between vehicles of different vehicle types.

Movement patterns which are carried out with the aid of multiple components may be designed in such a way that the individual movements of the different components, which produce the movement pattern together, proceed in parallel with one another (with at least a partial temporal overlap) or sequentially following one another (in series). As a result, the variability is again increased or the required time period for executing the movement pattern is shortened.

The movement pattern may be executed by the at least one component when the vehicle is stationary. This means that the vehicle is not moving in a movement direction during the execution of the movement pattern, i.e. it is moving neither forwards nor backwards. This does not refer to a movement of the vehicle which is caused by the execution of the movement pattern itself.

In some embodiments, the system control device and the vehicle control device are coupled wirelessly to one another. The wireless coupling may be realized, for example, via WLAN, Bluetooth, C-ITS (Cooperative Intelligent Transport Systems) or a universal mobile telecommunications system, such as 5G or 6G. As a result, reliable communication between the system control device and the vehicle control device is enabled. For example, the communication may therefore be realized, in particular, digitally so as to enable error corrections in the bidirectionally transmitted information.

The distinct movement pattern may also be distinct in the sense that it enables the identification of a specific vehicle and not only a particular vehicle type. This means that, even for vehicles of the same vehicle type, different identifiers with distinct movement patterns respectively stored therein may be provided. As a result, the method also enables the identification of actual specific individual vehicles, which means that the method is designed for additional application cases.

For the identification of the vehicle, a vehicle recognition means may be associated with the vehicle, which vehicle recognition means is also associated with the identifier. A distinction should be made between the vehicle recognition means and the license plate number of the vehicle. The vehicle recognition means essentially enables the vehicle to be identified again, for example within the zone of an autonomous or partly autonomous parking area or parking space area. With the aid of the vehicle characteristic, a specific vehicle may be reliably found again within the particular zone, for example if, after having previously been parked, the vehicle is to be provided again for a user after a particular time period.

The vehicle recognition means may be stored in the database with the respectively associated identifier.

The component may include at least one of a wiper, a vehicle wheel, an exterior mirror, a sliding sun window (also known as a sliding roof element; in the region of the vehicle roof; does not necessarily have to comprise a window) and a vehicle window. The vehicle wheel may be, for example, a movable vehicle front wheel. The vehicle window may be, for example, a movable side window. These components of a vehicle are movable, can be detected by external sensors and may be coupled to the particular vehicle control device in such a way that this latter may control a movement of the particular component. The components are therefore particularly suitable with regard to the present method. In addition, the components may be detected with the aid of various sensor types. It goes without saying that the particular vehicle may also comprise combinations of components of the above-mentioned types, which are used within the context of the present method to execute a movement pattern.

The respectively executed movement pattern may be designed to differ in respect of the particular component types. For example, a wiper may perform a complete or partial wiping movement, which may be repeated multiple times, wherein the movement speed of the wiper may be varied and/or pause intervals between individual wiping movements may be varied. The movable vehicle wheel may perform rotational movements about a vehicle vertical axis according to a predetermined angular position and angular speed, wherein multiple rotational movements in different directions may also accompany one another and, for example, pause intervals may be provided between the individual rotational movements. It goes without saying that the angular position of the individual rotational movements may be varied. The sliding sun window may be partially or fully opened and closed multiple times. Pause intervals between partial movements may likewise be provided during the movement of the sliding sun window. The exterior mirror may be partially or fully folded and unfolded multiple times. Furthermore, the movable vehicle window, for example a side window, may be moved partially or fully back and forth between a first end position and a second end position multiple times. All of these resultant movement patterns may include pause intervals between partial movements.

For the time period in which the particular movement pattern is executed, the vehicle control device may block the particular component from manual actuation, for example with the aid of a button. It may therefore be prevented that desired movement patterns specified by the vehicle control device are distorted through manual intervention.

In some embodiments, the detection of the vehicle takes place in relation to a predetermined detection space. As a result, the option is provided of triggering the method in an automated manner. For example, the method may be triggered in that a vehicle is positioned in the predetermined detection space. For example, the detection space may be an access zone (entry zone) of an autonomous or partly autonomous parking space area. The detection space is also defined as a specially designed zone in relation to which the at least one sensor is arranged, for example. This may eliminate the need to provide a plurality of sensors to cover disproportionately large detection zones.

The sensor preferably comprises at least one of a camera, radar, ultrasound and LiDAR. As a result, the detection of the movement pattern which is executed by the at least one movable component of the vehicle is, in particular, not dependent on the optical conditions. For example, the executed movement pattern may then also be detectable in the dark. As a result, the variability of the method may be further increased over that of previous approaches.

The method may be designed as a computer-implemented method, at least in part. This means that the fundamental method steps including the detection of the vehicle and the movement pattern, the communication, the control of the movable (vehicle) component and the identification of the vehicle may be executed with the aid of one or more data processing devices.

According to a further aspect, the disclosure also relates to a computer program product, comprising commands which, when the program is executed by a computer, prompt this latter to execute the method as described herein. The advantages achieved by the method described herein are also achieved in a corresponding manner by the computer program product.

According to an additional aspect, the disclosure also relates to a computer-readable storage medium, comprising commands which, when the program is executed by a computer, prompt this latter to execute the method as described herein. The advantages achieved by the method described herein are also achieved in a corresponding manner by the computer-readable storage medium.

Within the context of the disclosure, vehicles may include, in particular, land vehicles; namely, inter alia, off-road vehicles and road vehicles such as automobiles, buses, trucks and other utility vehicles. Vehicles may be manned or unmanned. Vehicles may be at least sometimes driven electrically.

All of the features explained with regard to the various aspects can be combined with other aspects individually or in (sub)combinations.

### BRIEF DESCRIPTION OF THE DRAWINGS

The disclosure and further advantageous embodiments and developments thereof are described and explained below with the aid of examples illustrated in the drawings, in which:

FIG. 1 shows a simplified schematic illustration of an example system for identifying a vehicle.

FIG. 2 shows a simplified schematic illustration of an example method for identifying a vehicle via a system.

### DESCRIPTION

The description detailed below, in conjunction with the accompanying drawings, in which the same numerals refer to the same elements, is intended to describe various embodiments of the disclosed subject matter and shall not represent the only embodiments. Each embodiment described in this disclosure serves merely as an example or illustration and should not be interpreted as preferred or advantageous over other embodiments. The illustrative examples contained herein make no claim to completeness and do not limit the claimed subject matter to the exact forms disclosed. Various modifications of the described embodiments are easily recognizable to a person skilled in the art and the general principles defined herein may be applied to other embodiments and applications without deviating from the spirit and scope of the embodiments described. The described embodiments are therefore not limited to the embodiments shown, but have the greatest possible range of applications compatible with the principles and features disclosed here.

All features disclosed below with respect to the embodiments and/or the accompanying figures may be combined with features of the aspects of the disclosure individually or in any sub-combination, provided the resultant feature combination is meaningful to a person skilled in the technological field.

For the purposes of the disclosure, the formulation “at least one of A, B and C” means, for example, (A), (B), (C), (A and B), (A and C), (B and C) or (A, B and C), including all further possible combinations, if more than three elements are listed. In other words, the wording “at least one of A and B” means, in general, “A and/or B”, namely “A” alone, “B” alone or “A and B”.

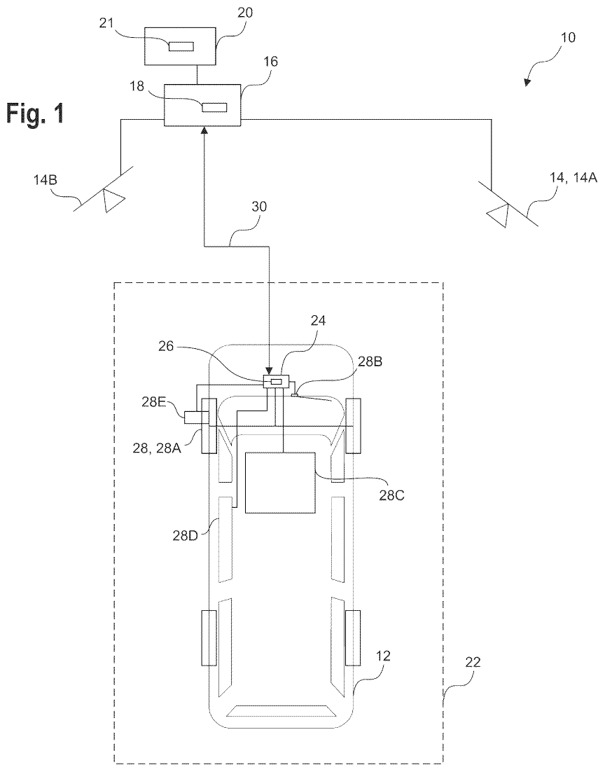

FIG. 1 shows a simplified schematic illustration of a system 10 for identifying a vehicle 12.

The system 10 comprises sensors 14, in this case a first sensor 14A and a second sensor 14B. The sensors 14 are designed to detect the vehicle 12. In particular, the sensors 14 are designed to detect movement patterns of movable components of the vehicle 12. In the present case, the sensors 14 are designed as LIDAR sensors. Alternatively, the sensors 14 may also comprise other sensor types, for example optically based cameras or radar.

The system 10 also comprises a system control device 16 having a data processing device 18, which is coupled at least to the sensors 14. According to the example presented here, the system control device 16 is also coupled to a memory device 20 in which a database 21 is stored.

The system control device 16 is designed to receive measurement data of the sensors 14 and, based on the measurement data of the sensors 14, to identify vehicles 12 as illustrated with the aid of the method described below.

According to the present example, the sensors 14 are designed, in particular, to detect the vehicle 12 within a detection space 22. This means that the detection of the vehicle 12 is triggered by the positioning of the vehicle 12 within the detection space 22. In this regard, the system control device 16 may interpret the measurement data of the sensors 14 in order to decide whether a vehicle 12 is positioned within the detection space 22.

The vehicle 12 forms part of the system 10. The vehicle 12 has at least one vehicle control device 24 having a data processing device 26.

In addition, the vehicle 12 comprises multiple movable components 28, which are each coupled to the vehicle control device 24 and which can be detected by the sensors 14. For example, the movable components 28 are part of an exterior shell of the vehicle 12, so that they may be detected by the sensors 14 which are arranged in the exterior space of the vehicle 12. In particular, the components 28 are movable in such a way that the movement patterns executed by the particular components 28 may also be detected by the sensors 14.

The vehicle control device 24 here is designed to control the movement of the particular components 28 accordingly from the movement pattern specified by the vehicle control device 24.

According to this example, the vehicle 12 comprises different components 28. The vehicle 12 illustrated here has movable (front) vehicle wheels 28A, movable wiper (blades) 28B, a movable sliding sun window 28C, a movable vehicle (side) window 28F and a movable exterior mirror 28E. For the sake of simplicity, corresponding further components, for example corresponding further exterior mirrors 28E, are not illustrated. Of course, the vehicle 12 may comprise a plurality of components 28 of the particular component type mentioned.

In addition, the vehicle control device 24 and the system control device 16 are designed to communicate wirelessly with one another. According to the present example, a bi-directional wireless signal transmission 30 is illustrated, which is realized here via WLAN. Alternatively, other transmission technology may be used, for example a universal mobile telecommunications system, C-ITS or Bluetooth. With the aid of the wireless signal transmission 30, digital information, in particular, may be forwarded between the signal control device 16 and the vehicle control device 24, for example an identifier.

The vehicle control device 24 may be coupled to a corresponding internal or external communication device (not illustrated here) to ensure the wireless communication with the system control device 16. The system control device 16 may likewise be coupled to an internal or external combination device (not illustrated here) for wireless communication with the vehicle control device 24.

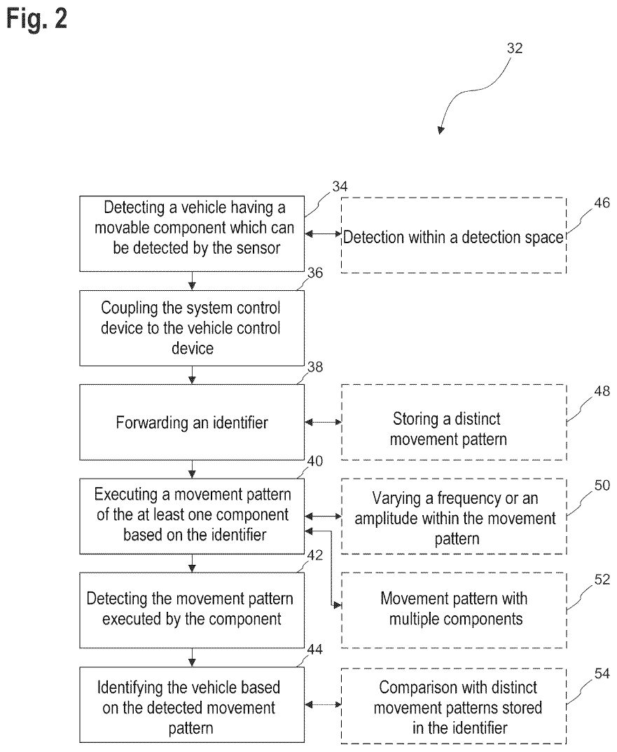

FIG. 2 shows a simplified schematic illustration of a method 32 for identifying a vehicle 12 via a system 10. Additional possible steps are illustrated by dashed lines.

The method 32 comprises the step 34, in which a vehicle 12 having at least one component 28 is detected. The component 28 here is such that it is movable, can be detected by a sensor 14 of the system 10 and is coupled to the vehicle control device 24. This means that the detection in respect of a vehicle 12 relates, in particular, to vehicles 12 that comprise suitable components 28 with the aid of which the present method 32 may be carried out.

The step 34 may be developed by the step 46 in that the detection of the vehicle 12 takes place in respect of a detection space 22. This means that the vehicle 12 must be positioned within the detection space 22 so that it may be detected by the sensors 14 according to step 34. As a result, it may be ensured that the sensors 14 do not have to cover a disproportionately large detection zone or that a plurality of sensors 14 are not required.

In the following step 36, the system control device 16 is coupled to the vehicle control device 24. According to the example illustrated here, the coupling is realized via the wireless signal transmission 30 with the aid of a universal WLAN.

The method 32 comprises the additional step 38, in which, starting from the system control device 16, an identifier is forwarded to the vehicle control device 24, for example with the aid of the wireless signal transmission 30. The identifier represents a protection mechanism for the method 32 since it may be used to ensure the integrity of the method 32.

The identifier may be designed in such a way that, according to the step 48, a distinct movement pattern is stored in the identifier. For example, the distinct movement pattern, which is to be executed by the component of the vehicle 12, may be encoded in the identifier. As a result, a precise expected value in respect of the movement pattern to be executed for the identification of the vehicle 12 may be forwarded to the vehicle 12 so that the subsequently detected movement pattern of the component 28 may be compared with a reference value, in this case the distinct movement pattern, in order to provide a robust identification mechanism in respect of the vehicle 12.

The identifier and/or the distinct movement pattern stored in the identifier may be specific to the vehicle type and/or specific to the vehicle. This means that the identifier and/or the distinct movement pattern stored in the identifier may essentially be useful for differentiating between vehicles 12 of different vehicle types or even for differentiating between vehicles 12 of the same vehicle type.

The method 32 then comprises the step 40, in which a movement pattern of the at least one component 28 of the vehicle 12 is executed based on the identifier received by the vehicle control device 24. To this end, the vehicle 12 may be stationary (with the exception of the moving components 28). To this end, the vehicle control device 24 is coupled to the particular component 28 of the vehicle 12. This also means that the vehicle control device 24 is designed to control the movement of the particular component 28 of the vehicle 12 precisely according to a movement pattern specified by the vehicle control device 24. The movement pattern here is ascertained by the vehicle control device 24 on the basis of an interpretation (or decoding) of the received identifier.

During the execution of the movement pattern of the component 28, according to the step 50 as a development of the step 40, at least the amplitude and/or the frequency of the movement within the movement pattern may be varied. By varying the amplitude and/or the frequency within the movement pattern, distinct information may be communicated by the movement pattern, which information may be detected with the aid of the sensors 14.

The step 40 may also be developed by the step 52, in which the movement pattern may be executed with the aid of multiple components 28. The individual movements of the components 28 may take place in parallel with one another (with a temporal overlap) or sequentially (one after another). The corresponding multiple components 28 are each controlled by the vehicle control device 24. In this regard, the vehicle control device 24 specifies a common movement pattern, which is executed by the components 28 controlled as a whole and can be detected by the sensors 14.

In addition, the method 32 comprises the step 42, in which a movement pattern executed by the component 28 of the vehicle 12 is detected by the at least one sensor 14. The corresponding measurement data of the movement pattern detected by the sensor 14 are then forwarded to the system control device 16.

Following the step 42, the method 32 comprises the step 44, in which the vehicle 12 is identified by the system control device 16 based on the detected movement pattern. The detected movement pattern here is generally compared with an expected movement pattern in order to enable the identification of the vehicle 12.

The step 44 may be developed by the step 54, in which the detected movement pattern may be compared with the distinct movement pattern, stored in the identifier, with the aid of the system control device 16, which identifier was forwarded to the vehicle control device 24 with the aid of the wireless signal transmission 30.

Within the context of steps 42 and 44, the system control device 16 uses a database 21, which is stored in a memory which is coupled to the system control device 16. The database 21 includes corresponding identifiers and distinct movement patterns stored in the respective identifiers.

In one alternative, the system control device 16 may comprise an algorithm which is designed to ascertain the distinct movement pattern based on the forwarded identifier. The transmission of the identifier may be realized, for example, with the aid of an encrypted exchange of a binary code. Likewise, the vehicle control device 24 may then also comprise the algorithm and ascertain the distinct movement pattern in a corresponding manner based on the forwarded identifier. In this case, a memory may be used, in which the identifier may be stored. However, it is possible to dispense with a database in which distinct movement patterns associated with the identifiers are stored.

In addition, the database 21 may comprise vehicle recognition means, with which the identified vehicles 12 are respectively associated and with which the respectively forwarded identifiers for the particular vehicle 12 are respectively associated in the database. With the aid of the vehicle recognition means, the particular vehicle 12 may then be re-identified at a later time, for example if the method 32 is applied within an autonomous or partly autonomous parking space area.

In this regard, a method 32 and a system 10 are provided, which can each be used to reliably identify vehicles 12 in an automated manner, wherein the identification of the particular vehicles 12 is additionally excluded from unwanted interference through protection mechanisms.

Specific examples disclosed here, in particular the system control device and the vehicle control device, use switching circuits (e.g. one or more switching circuits) to implement standards, protocols, methods or technologies disclosed here, to functionally couple two or more components, to generate information, to process information, to analyze information, to generate signals, to encode/decode signals, to convert signals, to transmit and/or to receive signals, to control other devices, etc. Circuits of any type may be used.

For example, a circuit such as the checking device comprises, inter alia, one or more data processing devices, such as a processor (e.g. a microprocessor), a central processing unit (CPU), a digital signal processor (DSP), an application-specific integrated circuit (ASIC), a field-programmable gate array (FPGA), a system on a chip (SoC) or the like, or any combinations thereof, and may comprise discrete digital or analog circuit elements or electronics or combinations thereof. For example, the circuit comprises hardware circuit implementations (e.g. implementations in analog circuits, implementations in digital circuits and the like, and combinations thereof).

For example, switching circuits comprise combinations of switching circuits and computer program products with software or firmware commands which are stored on one or more computer-readable memories and cooperate to prompt a device to execute one or more of the protocols, methods or technologies described here. For example, the circuit technology comprises switching circuits, such as microprocessors or parts of microprocessors, which require software, firmware and the like in order to operate. For example, the switching circuits comprise one or more processors or parts thereof and the associated software, firmware, hardware and the like.

In this disclosure, reference may be made to quantities and numbers. Unless explicitly stated, such quantities and numbers should not be regarded as limiting but as examples of the possible quantities or numbers with regard to the disclosure. In this regard, in the disclosure, the term “multiplicity” may also be used to refer to a quantity or number. In this regard, the term “multiplicity” means any number which is greater than one, e.g. two, three, four, five, etc. The expressions “for instance”, “approximately”, “close to”, etc. mean plus or minus 5% of the specified value.

Although the disclosure has been illustrated and described with reference to one or more embodiments, a person skilled in the art, after reading and understanding this description and the accompanying drawings, will be able to make equivalent changes and modifications.

1-11. (canceled)

12. A method comprising:
detecting a vehicle, the vehicle including a vehicle control device and at least one component, wherein the component is movable, is detectable by the sensor, and is coupled to the vehicle control device;
coupling a system control device to the vehicle control device;
reading an identifier from a database including respective identifiers and vehicle types, the database being independent of data about individual vehicles;
forwarding the identifier from the system control device to the vehicle control device;
executing a movement pattern of the at least one component of the vehicle based on the identifier;
detecting the movement pattern executed by the at least one component of the vehicle via a sensor coupled to the system control device; and
identifying the vehicle via the system control device based on the detected movement pattern independently of a license plate of the vehicle.

13. The method of claim 12, wherein a distinct movement pattern to be executed by the component is stored in the identifier, the method further comprising:
ascertaining, by the vehicle control device, the distinct movement pattern based on the received identifier; and
controlling, by the vehicle control device, the at least one component to execute the distinct movement pattern.

14. The method of claim 13, wherein identifying the vehicle depends on the movement pattern detected by the sensor being compared with the distinct movement pattern that is stored in the identifier.

15. The method of claim 12, wherein the movement pattern includes at least one frequency-dependent or amplitude-dependent variation of a movement of the at least one component of the vehicle.

16. The method of claim 12, wherein the at least one component includes multiple components, executing the movement pattern includes executing the movement pattern by the multiple components, and detecting the movement pattern includes detecting the multiple components by the sensor.

17. The method of claim 12, wherein the system control device and the vehicle control device are coupled wirelessly to one another.

18. The method of claim 12, wherein identifying the vehicle includes identifying the vehicle based on a vehicle recognition means associated with the vehicle, the vehicle recognition means being further associated with the identifier.

18. The method of claim 12, wherein the at least one component includes at least one of a wiper, a vehicle wheel, an exterior mirror, a sliding sun window, or a vehicle window.

20. The method of claim 12, wherein detecting the vehicle occurs in relation to a predetermined detection space.

21. The method of claim 12, wherein the sensor includes at least one of a camera, radar, ultrasound, or LiDAR.

22. A system comprising:
at least one sensor;
a system control device coupled to the sensor; and
a vehicle including a vehicle control device and at least one movable component, the at least one movable component being detectable by the sensor and coupled to the vehicle control device;
wherein the sensor is positioned to detect the vehicle and to detect a movement pattern executed by the at least one movable component of the vehicle;
the system control device and the vehicle control device are couplable to one another;
the vehicle control device is programmed to control the at least one movable component of the vehicle to execute a movement pattern based on an identifier;
the system control device is programmed to:
read the identifier from a database including respective identifiers and vehicle types, the database being independent of data about individual vehicles;
forward the identifier to the vehicle control device; and
identify the vehicle based on the detected movement pattern independently of a license plate of the vehicle.

23. The system of claim 22, wherein a distinct movement pattern to be executed by the component is stored in the identifier, and the vehicle control device is further programmed to:
ascertain the distinct movement pattern based on the received identifier; and
control the at least one movable component to execute the distinct movement pattern.

24. The system of claim 23, wherein the system control device is further programmed to identify the vehicle by comparing the movement pattern detected by the sensor with the distinct movement pattern that is stored in the identifier.

25. The system of claim 22, wherein the movement pattern includes at least one frequency-dependent or amplitude-dependent variation of a movement of the at least one movable component of the vehicle.

26. The system of claim 22, wherein the at least one movable component includes multiple components, wherein the vehicle control device is further programmed to execute the movement pattern by the multiple components, and the system control device is further programmed to detect the multiple components by the sensor.

27. The system of claim 22, wherein the system control device and the vehicle control device are wirelessly couplable to one another.

28. The system of claim 22, wherein the system control device is further programmed to identify the vehicle based on a vehicle recognition means associated with the vehicle, the vehicle recognition means being further associated with the identifier.

29. The system of claim 22, wherein the at least one movable component includes at least one of a wiper, a vehicle wheel, an exterior mirror, a sliding sun window, or a vehicle window.

30. The system of claim 22, wherein the system control device is further programmed to detect the vehicle in relation to a predetermined detection space.

31. The system of claim 22, wherein the sensor includes at least one of a camera, radar, ultrasound, or LiDAR.
